(19) United States
(12) Patent Application Publication
(10) Pub. No.: US 2015/0049506 A1
(43) Pub. Date: Feb. 19, 2015

(54) BACKLIGHT MODULE AND DISPLAY DEVICE USING SAME

(71) Applicant: HON HAI PRECISION INDUSTRY CO., LTD., New Taipei (TW)

(72) Inventor: CHENG-WEI LEE, New Taipei (TW)

(21) Appl. No.: 14/459,586

(22) Filed: Aug. 14, 2014

(30) Foreign Application Priority Data
Aug. 14, 2013 (TW) 102129114

(51) Int. Cl. F21V 8/00

(52) U.S. Cl. CPC G02B 6/002; G02B 6/0021; G02B 6/0016; G02B 6/0068; G02B 6/0073
USPC 362/608

(57) ABSTRACT

A backlight module includes a light guide plate and a number of light sources. The light guide plate includes a first surface and a number of projecting portions extending from the first surface corresponding to the light sources. Each projection portion includes a second surface facing a light source. A number of microstructures are formed on the second surface for increasing the divergence angle of the light incident to the light guide plate through the second surface.

### FIELD

The disclosure generally relates to backlight technologies, and more particularly to a backlight module and a display device using the same.

### BACKGROUND

A backlight module of a display device usually includes a light guide plate and a number of light sources. The light sources are positioned adjacent to an incident surface of the light guide plate. However, in order to miniaturize the display device, a distance between the incident surface and the light sources becomes smaller and smaller, and then a uniformity of the light emitted from the backlight module is adversely affected.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a first embodiment of a display device.

FIG. 2 is an isometric view of a backlight module of the display device of FIG. 1.

FIG. 3 is a cross-sectional view of the backlight module of FIG. 2, taken along line II-II.

FIG. 4 is an isometric view of a second embodiment of a display device.

FIG. 5 is an isometric view of a backlight module of the display device of FIG. 4.

FIG. 6 is a cross-sectional view of the backlight module of FIG. 5, taken along line IV-IV.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

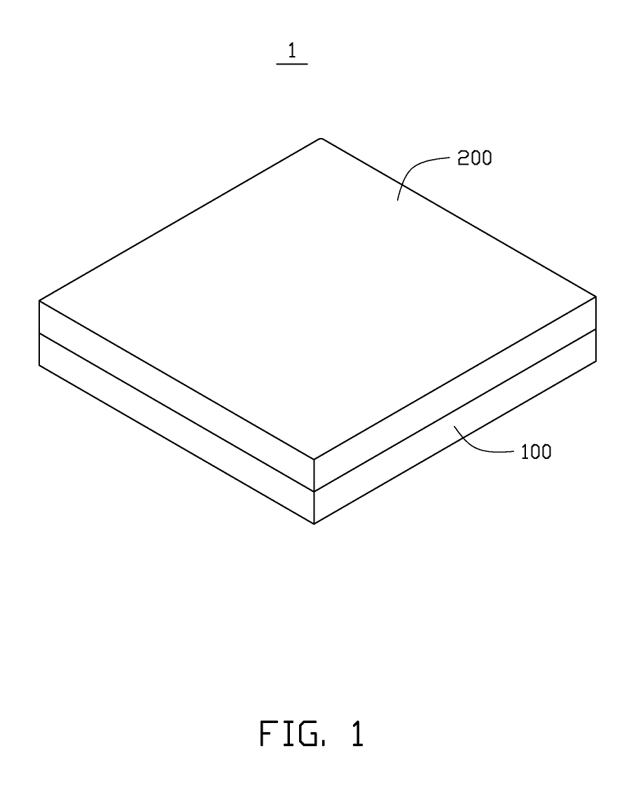

FIG. 1 is an isometric diagram of a first embodiment of a display device. Referring to FIG. 1, the display device 1 includes a backlight module 100 and a display panel 200. The backlight module 100 is disposed at a side of the display panel 200 and provides light for the display panel 200. In this embodiment, the display panel 200 is a liquid crystal display panel.

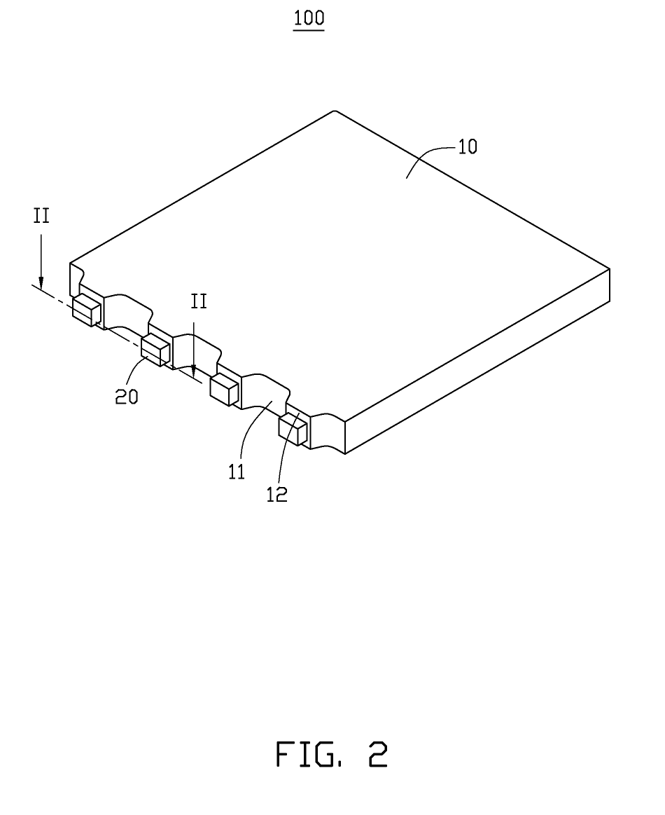

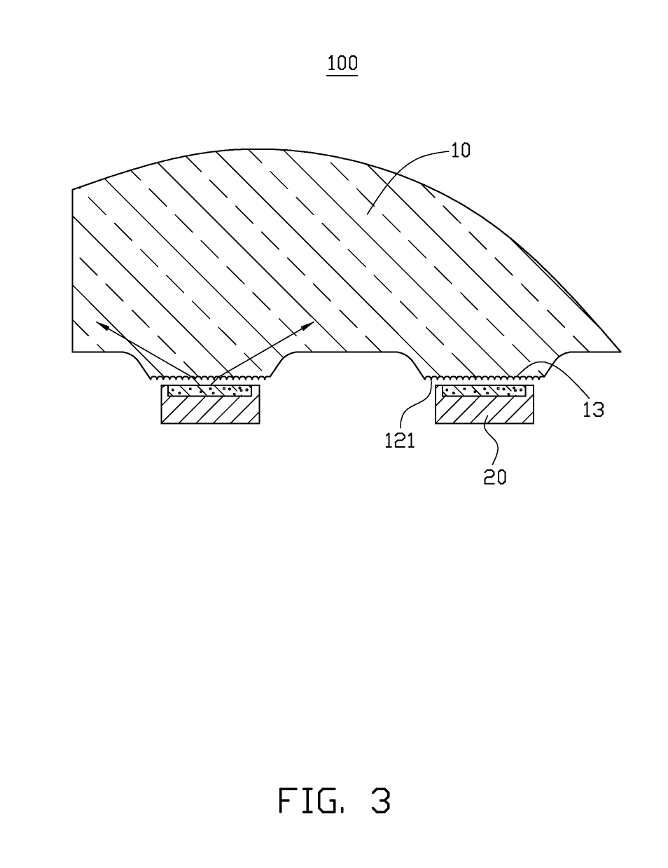

FIG. 2 is an isometric diagram of a backlight module of the display device of FIG. 1. FIG. 3 is a cross-sectional view of the backlight module taken along line II-II of FIG. 2. Referring to FIGS. 2 and 3, the backlight module 100 includes a light guide plate 10 and a number of light sources 20. In this embodiment, the light sources 20 are light emitting diodes.

The light guide plate 10 is a rectangular parallelepiped. The light guide plate 10 includes a first surface 11 and a number of projecting portions 12 extending from the first surface 11 corresponding to the light sources 20. The projecting portions 12 are evenly spaced with a predetermined interval. Each projection portion 12 includes a second surface 121 facing a light source 20. An area of the second surface 121 is greater than a light output surface of the light source 20. A number of microstructures 13 are formed on the second surface 121 for increasing the divergence angle of the light incident to the light guide plate 10 through the second surface 121. In this embodiment, the microstructures 13 are a number of cylindrical grooves. The microstructures 13 are formed by a laser process or an etching process.

The projecting portions 12 refract the light emitted from the light source 20 when the light incident to the second surface 121. The microstructures 13 increase the divergence angle of the light incident to the light guide plate 10 through the second surface 121. Thus, the uniformity of the light emitted from the backlight module 100 is improved.

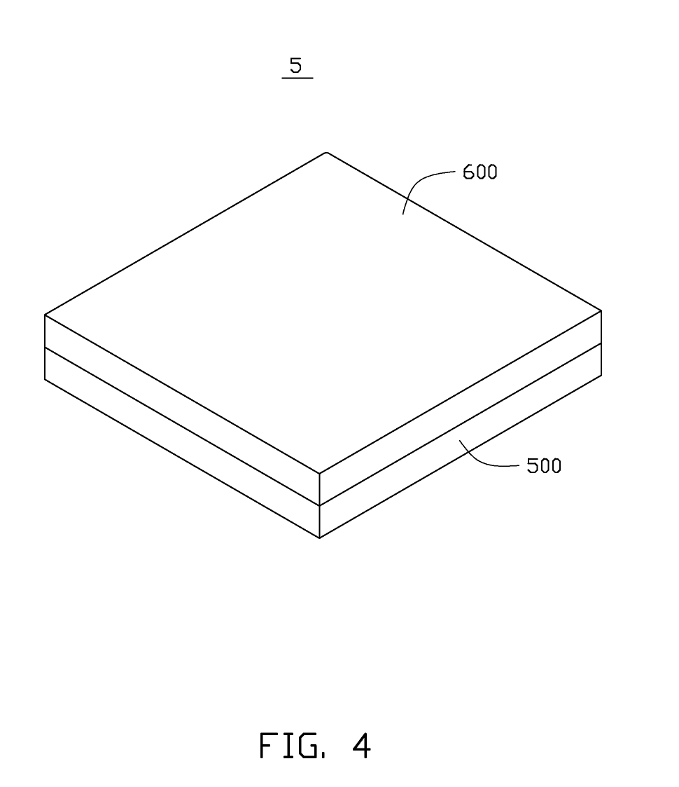

FIG. 4 is an isometric diagram of a second embodiment of a display device. Referring to FIG. 4, the display device 5 includes a backlight module 500 and a display panel 600. The backlight module 500 is disposed at a side of the display panel 600 and provides light for the display panel 600. In this embodiment, the display panel 600 is a liquid crystal display panel.

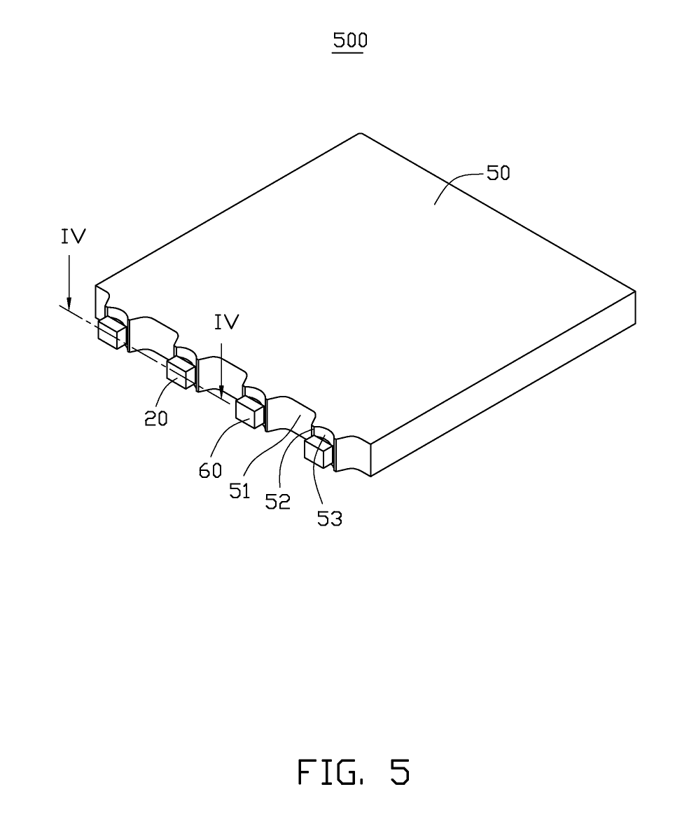

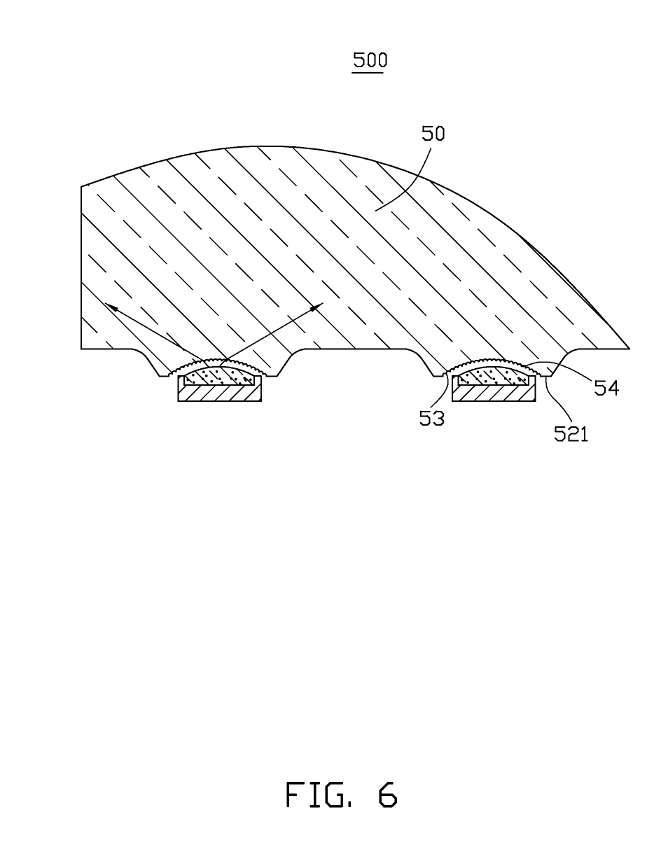

FIG. 5 is an isometric diagram of a backlight module of the display device of FIG. 4. FIG. 6 is a cross-sectional view of the backlight module taken along line IV-IV of FIG. 5. Referring to FIGS. 5 and 6, the backlight module 500 includes a light guide plate 50 and a number of light sources 60. In this embodiment, the light sources 60 are light emitting diodes.

The light guide plate 50 is a rectangular parallelepiped. The light guide plate 50 includes a first surface 51 and a number of projecting portions 52 extending from the first surface 51 corresponding to the light sources 60. The projecting portions 52 are evenly spaced with a predetermined interval. Each projection portion 52 includes a second surface 521 facing the light source 60. In this embodiment, the second surface 521 is a concave surface 53. At least a part of each light source 60 is housed in the concave surface 53. An area of the second surface 521 is greater than a light output surface of the light source 60. A number of microstructures 54 are formed on the second surface 521 for increasing the divergence angle of the light into the light guide plate 50 through the concave surface 53. In this embodiment, the microstructures 54 are a number of cylindrical grooves. The microstructures 54 are formed by a laser process or an etching process.

The projecting portions 52 refract the light emitted from the light source 60 when the light incident to the projecting portions 52. The microstructures 54 increase the divergence angle of the light incident to the light guide plate 50 through the concave surface 53. Thus, the uniformity of the light emitted from the backlight module 500 is improved.

It is believed that the discussed embodiments and their advantages will be understood from the foregoing description, and it will be apparent that various changes may be made thereto without departing from the disclosure or sacrificing all of its material advantages. The embodiments discussed herein do not limit the following claims.

What is claimed is:

1. A backlight module comprising:
a number of light sources; and
a light guide plate comprising:
a first surface; and
a number of projecting portions extending from the first surface corresponding to the light sources, each projection portion comprising a second surface facing a light source, the second surface forming a number of microstructures for increasing an divergence angle of the light incident to the light guide plate through the second surface.

2. The backlight module of claim 1, wherein the second surface is a concave surface, the microstructures are formed on the concave surface.

3. The backlight module of claim 2, wherein at least a part of each light source is housed in a concave surface.

4. The backlight module of claim 1, wherein the microstructures are a number of cylindrical grooves.

5. The backlight module of claim 1, wherein the microstructures are formed by a laser process or an etching process.

6. The backlight module of claim 1, wherein the projecting portions are evenly spaced with a predetermined interval.

7. The backlight module of claim 1, wherein the light guide plate is a rectangular parallelepiped.

8. The backlight module of claim 1, wherein the light sources are light emitting diodes.

9. A display device comprising:
a display panel; and
a backlight module disposed at a side of the display panel and providing backlight for the display panel comprising:
a number of light sources; and
a light guide plate comprising:
a first surface; and
a number of projecting portions extending from the first surface corresponding to the light sources, each projection portion comprises a second surface facing a light source, the second surface forming a number of microstructures for increasing the divergence angle of the light incident to the light guide plate through the second surface.

10. The display device of claim 9, wherein the second surface is a concave surface, the microstructures are disposed on the concave surface.

11. The display device of claim 10, wherein at least a part of each light source is housed in a concave surface.

12. The display device of claim 9, wherein the microstructures are a number of cylindrical grooves.

13. The display device of claim 9, wherein the microstructures are formed by a laser process or an etching process.

14. The display device of claim 9, wherein the projecting portions are evenly spaced with a predetermined interval.

15. The display device of claim 9, wherein the light guide plate is a rectangular parallelepiped.

16. The display device of claim 9, wherein the light sources are light emitting diodes.
